(19) United States
(12) Patent Application Publication
(10) Pub. No.: US 2024/0025217 A1
(43) Pub. Date: Jan. 25, 2024

(54) HOT HUBS

(71) Applicant: HOT HUBS, LLC, Titusville, FL (US)

(72) Inventors: Christopher WOODRUFF, Titusville, FL (US); David WOODRUFF, Titusville, FL (US); Michael WOODRUFF, Titusville, FL (US)

(21) Appl. No.: 18/249,156

(22) PCT Filed: Oct. 15, 2021
(86) PCT No.: PCT/US2021/071909

§ 371 Date: Apr. 14, 2023

Related U.S. Application Data
(60) Provisional application No. 63/092,196, filed on Oct. 15, 2020.

(51) Int. Cl. B60C 23/04; G01M 17/02

(52) U.S. Cl. CPC B60C 23/0498; G01M 17/02; B60C 23/0479

(57) ABSTRACT

A tire monitoring system including a monitoring module for mounting on a wheel. The monitoring module having a transmitter configured to wirelessly communicate with a mobile device of a user, a pneumatic sensor receiver communicatively coupled with the transmitter, a temperature sensor communicatively coupled with the transmitter, and a vibration sensor communicatively coupled with the transmitter.

### PRIORITY CLAIM AND CROSS-REFERENCE

The present application is related to and claims priority from U.S. Provisional Patent Application 63/092,196, filed on Oct. 15, 2020, the entirety of which is hereby incorporated herein by reference.

### BACKGROUND

The majority of trailers, especially boat trailers, have one or more axles that endure severe hardships—submerging in water and heat from the road as well as friction within the bearings. The result is bearings seize and tires that may deflate or go completely flat during travel without the awareness of the driver, until catastrophic damage is unavoidable. This provisional patent will present a device that fits axels that provides the driver with real time information regarding the axels that will provide safety for all drivers.

Many vehicles have one or more wheels that may malfunction and fail during travel without the driver becoming immediately aware of the condition. These include tractor-trailer combinations, motor homes, buses and various types of motor vehicles and trailers being towed that have axles mounted with two or more tires, or tandem rear axles that may have a total of four, six or eight tires. Unlike those of motorcars, drivers of these vehicles cannot sense that a wheel has an issue, whether it is an overheating bearing, low tire pressure, or suffered a complete failure and is no longer functioning in some cases. The large size and heavy weight of these vehicles isolate a driver from noise and vibration created by a disturbance in the wheel(s). Likewise, a driver towing another vehicle is insulated from any sensation of an issue arising with the wheel(s) on the towed vehicle.

There are many variables that can lead to a wheel failure. Low tire pressure is one such factor if it goes undetected. If a tire is low in pressure, an excessive amount of heat can be generated due to the increased contact with the surface of the road. While traveling on an interstate highway at speeds of between 55 and 65 m.p.h., a blowout can cause extensive damage, especially when it goes undetected. The tire disintegrates and its debris damages the vehicle or trailer, often extensively. The wheel hits against the pavement, and usually suffers damage. In the case of dual rear wheels, where there is four wheels per axle, continued motion with one of the tires deflated may even cause the deflated tire to catch fire. There have been cases reported in which such a fire has caused total loss of the vehicle or trailer.

Misfunctioning hubs are another cause of concern. Being the component, which attaches the wheel(s) to the vehicle, an issue with the hub can have dire consequences on the vehicle. It is not uncommon for a bearing(s) to perform poorly and build up heat due to increased friction. Not only can this friction result in a buildup of heat but can increase it to such a degree that the bearings themselves can melt and cause the wheel to cease, resulting in a complete failure of the wheel assembly as a whole. Not only is this issue very costly and time lengthy but can result in dangerous circumstances arising. The immobilized vehicle can cause a danger not only to its passengers, but also bystanders as sudden road blockages present a serious risk. There have even been cases in which a hub failure has resulted in fires and even the wheel separating amid driving. Both of these present immediate risks to both the passengers and bystanders.

Most disconcerting about a vehicle's wheel failure is, however, that it affects the load carrying capability, steering, braking and overall control of the vehicle. Loss of a load bearing wheel may result in a driver losing control and causing damage to the vehicle, passengers, bystanders, and other property as well as passengers of other vehicles.

Needless to say, the continual prospect of losing a wheel makes drivers cars, trucks, motorhomes, tractors and other large or towing vehicles very uneasy.

Despite numerous instrument panels in vehicles being over-populated by gauges and lights for providing various warnings, most large vehicles nor trailers have a wheel monitor to gauge the status that drivers who spend a lot of time on the road desperately want and need. In addition to the failure to recognize the importance of detecting at an early stage low tire pressure to prevent blowouts, there is at least one other reason for the absence of tire pressure monitoring systems: prior art tire pressure monitors have adopted expensive and impractical approaches to this problem; and/or they only regarded a single facet of the issue at hand, neglecting to see the whole picture.

In reviewing existing systems, there are several examples of tire pressure monitors and alarm systems. These are typically fastened to the rim of the wheel and require that a hole be drilled through the wheel. Existing systems include a transducer of some sort that converts the pressure to a signal for communicating the pressure to a remote display.

The disadvantage of these tire pressure monitors is that the transducers are mounted through the wheel rim. Thus, the wheel must be either specially manufactured or adapted (if possible) with holes that are drilled in the wheel to receive the transducers. As holes cause undue stress on the wheel retrofitting preexisting wheels, it gives rise to safety and liability problems. Thus, they must be manufactured for these systems as original equipment. However, they must meet strict Department of Transportation guidelines and undergo stress tests before approval.

These systems also require that the wheel be removed from the vehicle and disassembled to gain access to the transducers for service. Furthermore, they require some sort of electrical connection between the transducer and any remote monitoring device. With a rotating wheel, this electrical connection requires special contacts, complicating the system, introducing added cost and reducing reliability.

The problem of connecting the transducer to a monitor has been solved in part by radio frequency communications. As shown in U.S. Pat. No. 4,890,090 of Ballyns, a pressure transducer is coupled to a radio frequency transmitter that is mounted within the tire and secured to the wheel rim. Although it has the advantage of wireless communication of the pressure to a remotely placed monitor, it suffers from the same disadvantages of the rim mounted transducers: it is difficult to install and service and requires special adaption of the wheel.

To avoid this communication problem, it is possible to indirectly monitor the condition of the tire using tire rotation sensors like those installed as original equipment on vehicles with anti-lock braking and some all-wheel drive systems. To detect a deflating tire, these sensors are monitored for abnormal changes in rotation speeds of the tire indicating deflation. Doing so requires sophisticated sensors, data processing equipment and algorithms, and a vehicle originally equipped with this advanced and expensive technology. It is a sophisticated approach, but one that is not feasible for most vehicles such as buses, trucks and motor homes currently being manufactured and on the road that are not using this technology.

Another approach avoids altogether mounting transducers on a tire. Yet it is just as complicated and expensive. An elaborate, and extremely expensive air pressure line is built into the car that runs from a wheel, through a hub and down an axle to a sensor located within the vehicle. This approach is generally available only to the most sophisticated and expensive vehicles and must be installed as original equipment.

Despite previous substantial efforts to improve the safety of tires, current tire pressure monitoring systems continue to run in the vein of being expensive and elaborate; they require substantial modification to wheels and to the car for their use; and they offer methods having little to no feasibility for retrofitting the millions of ordinary wheels that are in use and will continue to be manufactured and used.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a view of a temperature monitoring module, in accordance with some embodiments.

FIG. 2 is a view of a temperature monitoring module, in accordance with some embodiments.

FIG. 3 is an exploded view of a monitoring module installed on a wheel, in accordance with some embodiments.

FIG. 4 is a detailed exploded view of a monitoring installed on a wheel, in accordance with some embodiments.

FIG. 5 is a high level view of a hub monitoring system, in accordance with some embodiments.

FIG. 6 is a high level block diagram of a system, in accordance with some embodiments.

FIG. 7 is a flow chart of a method of operating the hub monitoring system, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

One or more embodiments of the present invention overcome one or more of the aforementioned and other disadvantages of prior art systems and provide for an elegantly simple, relatively low cost, reliable and easily repairable or replaceable system for warning a driver of one or more abnormal wheel conditions to prevent possible wheel issues. One or more embodiments are designed to be added or retrofitted to tires of existing vehicles such as busses, motor homes, trucks, trailers or the like.

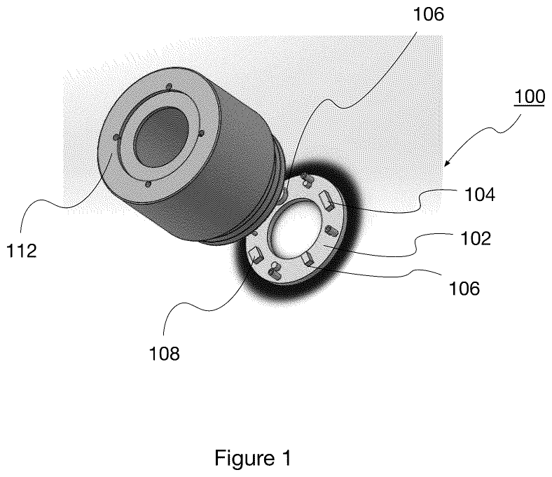

FIG. 1 is a view of a wheel monitoring system 100, in accordance with some embodiments. Components of the system 100 include a monitoring module 102 having a pneumatic sensor receiver 104, a thermal sensor 106, a vibration sensor 108, and a transmitter 110 thereon that may be fastened directly onto hub cap of a tire or pressed into the hub of the wheel to monitor the status of the wheel. In an embodiment, the transmitter 110 is mounted with each sensor within a housing(s) that forms a transmitter and sensor unit of an overall system. Each monitoring module 102 may function independently or together to monitor a variable number of conditions present on each wheel. Installation and service is thus very simple, and the monitoring module 102 fits all standard wheel wells, hubs, and tires. Thus, the monitoring module 102 is usable with almost any type of trailer or vehicle. No alterations to the wheel or complicated installation procedures are required.

Monitoring module 102 is connectable with a hub cap 112 in order to be mounted to the center bore of the wheel. In some embodiments, the monitoring module 102 is mounted to the center bore of the wheel prior to installation of hub cap 112. Hub cap 112 is press fit (friction fit) within center bore of the wheel and monitoring module 102 is between hub cap 112 and the wheel. In this manner, the fit of hub cap 112 in the center bore of the wheel retains the monitoring module 102 in place. In some embodiments, monitoring module 102 is mounted to hub cap 112 via one or more fastening bolts. In some embodiments, monitoring module 102 is mounted to hub cap 112 via threading. In some embodiments, monitoring module 102 is mounted to hub cap 112 via one or more fastening bolts passing from hub cap 112 through the monitoring module and connecting with the wheel. In some embodiments, monitoring module 102 is configured to be screwed onto a portion of the wheel, e.g., interior to the center bore of the wheel.

Hub cap 112 covers the center bore of the wheel. In at least some embodiments, hub cap 112 is press fit into the center bore. In at least some embodiments, hub cap 112 is threaded into the center bore.

The pneumatic sensor receiver 104, thermal sensor 106, vibration sensor 108, and transmitter 110 are communicatively connected on monitoring module 102. In some embodiments, monitoring module 102 is a circuit board having the sensor and transmitter components mounted thereto.

The pneumatic sensor receiver 104 is configured to communicate with a tire pressure sensor in order to determine the tire pressure of the tire on the wheel to which the monitoring module 102 is attached. The tire pressure sensor is a standard tire pressure sensor known to persons of skill in the art. In some embodiments, the tire pressure sensor determines tire pressure using an indirect tire pressure measurement, e.g., wheel speed sensing. In at least some embodiments, the tire pressure sensor is affixed to the valve stem of the tire. In at least some embodiments, the tire pressure receiver is part of the tire pressure sensor. In at least some embodiments, the tire pressure sensor communicates the tire pressure reading to the pneumatic sensor receiver 104. In at least some embodiments, the tire pressure sensor communicates directly with the mobile device of the user. In at least some embodiments, the tire pressure sensor communicates directly with the user mobile device without communicating with the monitoring module 102.

The thermal sensor 106 is configured to determine the temperature of the tire on the wheel to which the monitoring module 102 is attached. In some embodiments, the thermal sensor 106 determines the temperature of the tire using infrared signals transmitted toward the tire. In at least some embodiments, the thermal sensor 106 directly measures the temperature via measuring a voltage and/or resistance level. The thermal sensor 106 being placed adjacent to the bearings of the wheel allows measurement of the adjacent bearing temperature.

The vibration sensor 108 is configured to determine the vibrations of the tire on the wheel to which the monitoring module 102 is attached. In some embodiments, the vibration sensor 108 is a piezoelectric accelerometer that senses vibrations of the tire. In at least some embodiments, the vibration sensor 108 detects one or more harmonic frequencies over time present during operation of the wheel.

Because a tire with an increased hub temperature is a candidate for a hub failure, a tire with abnormal vibration is a candidate for lug nut failure and a tire with abnormally low pressure is a candidate for a blowout, a system which monitors all the these variables and provides early warning of excessive hub/tire heat, excessive vibrations, and an abnormally low pressure and would go a long way toward providing peace of mind to the drivers, as well as providing safety for all persons involved, prolong the life of hubs, lug nuts, and tires; prevent safety risks; and save time.

The transmitter 110 (also referred to as a communication module) is configured to communicate with each of the pneumatic sensor receiver 104, thermal sensor 106, and vibration sensor 108. The transmitter 110 is communicatively connected in a wired manner with the pneumatic sensor receiver 104, thermal sensor 106, and vibration sensor 108. In some embodiments, the transmitter 110 is connected to the sensors via a bus or other network configuration.

The transmitter 110 is also configured to communicate with a mobile device of a user, e.g., a smartphone or other hand-held device or processing system. In at least some embodiments, the mobile device is a dashboard mounted electronic unit. In at least some embodiments, the mobile device is integrated into the dashboard of the vehicle. The transmitter 110 is able to communicate wirelessly with the mobile device, e.g., using Bluetooth or other communication mechanisms.

In some embodiments, additional sensors are added to monitoring module 102 to detect additional tire parameters.

Monitoring module 102 further includes a power source to power the components. In some embodiments, the power source is a battery. In some embodiments, the power source is a user-replaceable battery. In some embodiments, the power source is a rechargeable battery. In some embodiments, the power source is an internal permanent battery. In some embodiments, the power source is a self-powered centrifugal force based power source in which rotation of the monitoring module 102 generates sufficient power for operating the sensors and the transmitter.

Monitoring module 102, by way of transmitter 110, is configured to communicate with the user mobile device. In particular, the mobile device includes a control application executing thereon to communicate with the transmitter 110 and display information received from the transmitter to the user. The displayed information includes temperature, pressure, and vibration information related to the tire on which the monitoring module 102 is mounted.

In some embodiments, the control application is executable on one or more mobile device, e.g., Android OS, Apple iOS, Windows OS. In some embodiments, the control application is configured to provide feedback to the user and also provide adjustable alerts based on one or more of temperature, pressure, or vibration information received from the monitoring module 102. In some embodiments, the control application is configured to communicate with more than one monitoring module 102 at a time. For example, the control application is able to communicate with each monitoring module 102 installed on each tire of a vehicle.

The monitoring module 102 fastens to the exterior of any standard tire and monitors it for safety purposes as described above. The monitoring module 102 was designed and created for instances that require operation on roads, e.g., large vehicles with three or more axles, tow behind trailers, or another motor vehicle that lacks a tire monitoring system.

With respect to the above description then, it is to be realized that the optimum dimensional relationships for the parts of one or more embodiments of the invention, to include variations in size, materials, shape, form, function and manner of operation, assembly and use, would be understood by one skilled in the art, and all equivalent relationships to those illustrated in the drawings and described in the specification are intended to be encompassed by one or more embodiments of the present invention.

Therefore, the foregoing is considered as illustrative only of the principles of one or more embodiments of the invention. Further, since numerous modifications and changes will readily occur to those skilled in the art, it is not desired to limit the embodiments of the invention to the exact construction and operation shown and described, and accordingly, all suitable modifications and equivalents may be resorted to, falling within the scope of one or more embodiments of the invention.

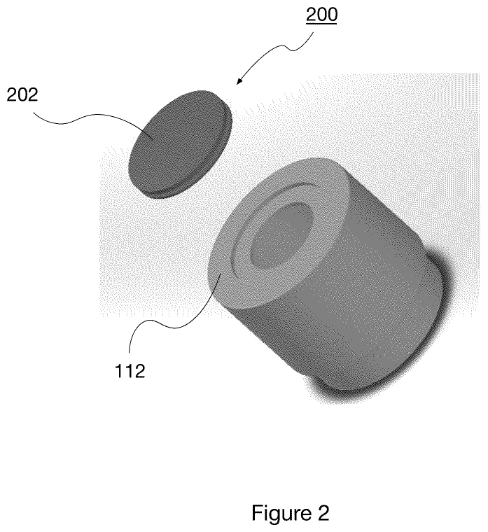

FIG. 2 is a view of a monitoring system 200, in accordance with some embodiments. Monitoring system 200 includes a monitoring module 202 including the same elements as monitoring module 100 (FIG. 1); however, monitoring module 202 is configured to be press fit into the outside of hub cap 112, i.e., distal from the wheel to which the monitoring module is to be attached. Monitoring module 202 faces inward toward the wheel and the sensors and transmitter are on the side of the monitoring module facing the wheel. In at least some embodiments, monitoring module 202 is press fit into a grease refill hole inside hub cap 112.

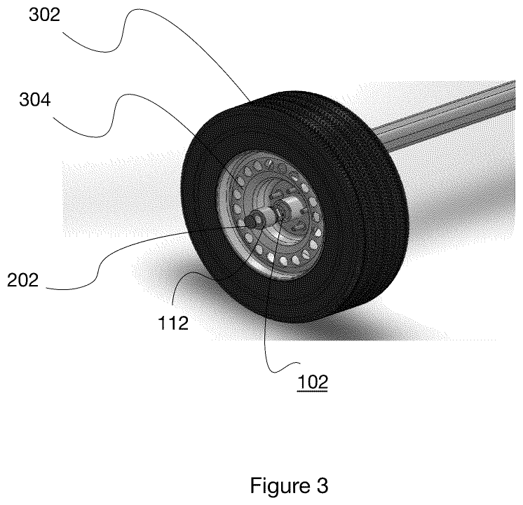

FIG. 3 is an exploded view of two monitoring modules 102, 202 installed on a wheel 304, in accordance with some embodiments. Wheel 304 includes a tire 302 mounted thereon. As with the FIG. 1 embodiment, monitoring module 102 is fit into hub cap 112 between the hub cap and the wheel 304. As with the FIG. 2 embodiment, monitoring module 202 is fit onto hub cap 112 which is pressed into the hub of wheel 304. In some embodiments, two monitoring modules are used to provide redundant sensor capabilities in case of failure.

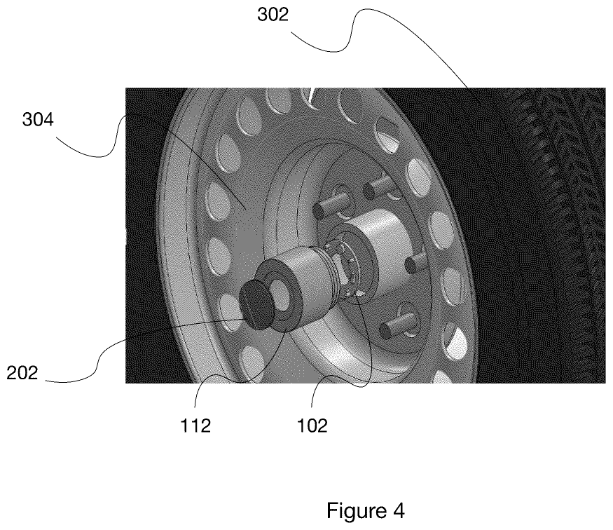

FIG. 4 is a detailed exploded view of two monitoring modules 102, 202 installed on wheel 304 as in FIG. 3, in accordance with some embodiments. Wheel 304 includes a tire 302 mounted thereon. As with the FIG. 1 embodiment, monitoring module 102 is fit into hub cap 112 between the hub cap and the wheel 304. As with the FIG. 2 embodiment, monitoring module 202 is fit onto hub cap 112 which is pressed into the hub of wheel 304. In some embodiments, two monitoring modules are used to provide redundant sensor capabilities in case of failure.

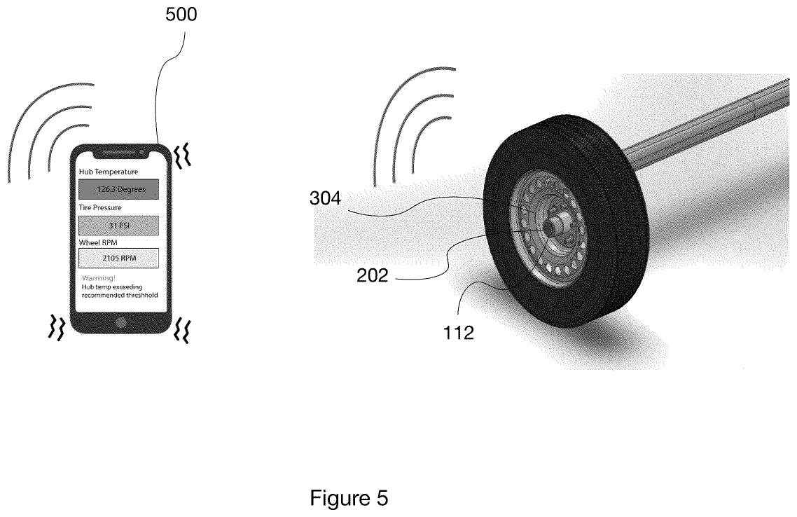

FIG. 5 is a high level view of a hub monitoring system 200 and a mobile device 500, in accordance with some embodiments. Mobile device 500 communicates wirelessly with hub monitoring system 200, and particularly with monitoring module 202. Still further, mobile device 500 is configured to wirelessly communicate with transmitter 110 on monitoring module 202 as described herein.

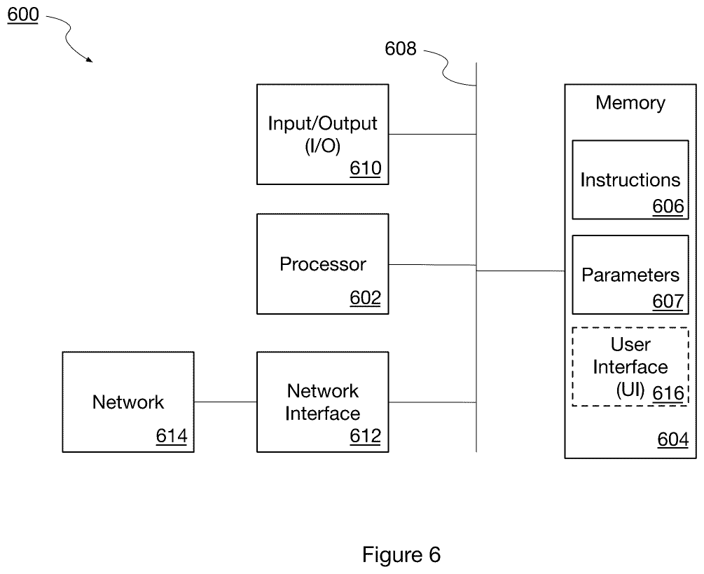

In some embodiments, mobile device 500 receives information regarding one or more of tire pressure, tire temperature, and tire vibration levels via transmitter 110 communicating with one or more of pneumatic sensor receiver 104, thermal sensor 106, or vibration sensor 108. In some embodiments, mobile device 500 is configured to compare the received information with stored parameters in memory 604 (FIG. 6) and determine whether one or more of the information is outside a predetermined range of the expected value of the parameter. In at least some embodiments, if the information differs from the stored parameter value by more than a predetermined amount an alert is generated. If the information is determined to be outside the predetermined range, the mobile device 500 generates an alert to the user of the mobile device. In at least some embodiments, the alert includes one or more of a visual, audio, or haptic signal to alert the user.

The inventor is not aware of an adequate trailer monitoring system available for public sale. The present system is an easily installable aftermarket solution that can prevent a possibly deadly issue. By fastening this monitoring module to a wheel, the system displays hub temperature, tire pressure, tire temperature, wheel vibrations and more to the user. This is a simple, yet effective solution to a long-lived issue, it can change the safety of our roads for the better.

FIG. 6 is a block diagram of processing system 600 in accordance with some embodiments. The user mobile device is an example of processing system 600.

In some embodiments, system 600 is included as a part of monitoring module 102. Methods described herein, in accordance with one or more embodiments, are implementable, for example, using system 600, in accordance with some embodiments.

In some embodiments, system 600 is a general purpose computing device including a hardware processor 602 and a non-transitory, computer-readable storage medium 604. Storage medium 604, amongst other things, is encoded with, i.e., stores, computer program code 606, i.e., a set of executable instructions. Execution of instructions 606 by hardware processor 602 represents implementation of a portion or all of the methods described herein in accordance with one or more embodiments (hereinafter, the noted processes and/or methods).

Processor 602 is electrically coupled to computer-readable storage medium 604 via a bus 608. Processor 602 is also electrically coupled to an I/O interface 610 by bus 608. A network interface 612 is also electrically connected to processor 602 via bus 608. Network interface 612 is connected to a network 614, so that processor 602 and computer-readable storage medium 604 are capable of connecting to external elements via network 614. For example, network interface 612 is usable to communicate with transmitter 110 of monitoring module 102. Processor 602 is configured to execute computer program code 606 encoded in computer-readable storage medium 604 in order to cause system 600 to be usable for performing a portion or all of the noted processes and/or methods. In one or more embodiments, processor 602 is a central processing unit (CPU), a multi-processor, a distributed processing system, an application specific integrated circuit (ASIC), and/or a suitable processing unit.

In one or more embodiments, computer-readable storage medium 604 is an electronic, magnetic, optical, electromagnetic, infrared, and/or a semiconductor system (or apparatus or device). For example, computer-readable storage medium 604 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 604 includes a compact disk-read only memory (CD-ROM), a compact disk-read/write (CD-R/W), and/or a digital video disc (DVD).

In one or more embodiments, storage medium 604 stores computer program code 606 configured to cause system 600 (where such execution represents (at least in part)) to be usable for performing a portion or all of the noted processes and/or methods. In one or more embodiments, storage medium 604 also stores information which facilitates performing a portion or all of the noted processes and/or methods. In one or more embodiments, storage medium 604 stores parameters 607 including settings for alerts related to temperature, pressure, and vibration as disclosed herein.

System 600 includes I/O interface 610. I/O interface 610 is coupled to external circuitry. In one or more embodiments, I/O interface 610 includes a keyboard, keypad, mouse, trackball, trackpad, touchscreen, and/or cursor direction keys for communicating information and commands to processor 602.

System 600 also includes network interface 612 coupled to processor 602. Network interface 612 allows system 600 to communicate with network 614, to which one or more other computer systems are connected. Network interface 612 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 600.

System 600 is configured to receive information through I/O interface 610. The information received through I/O interface 610 includes one or more of instructions, data, and/or other parameters for processing by processor 602. The information is transferred to processor 602 via bus 608. In some embodiments, system 600 is configured to receive information related to a UI through I/O interface 610. The information is stored in computer-readable medium 604 as user interface (UI) 616.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

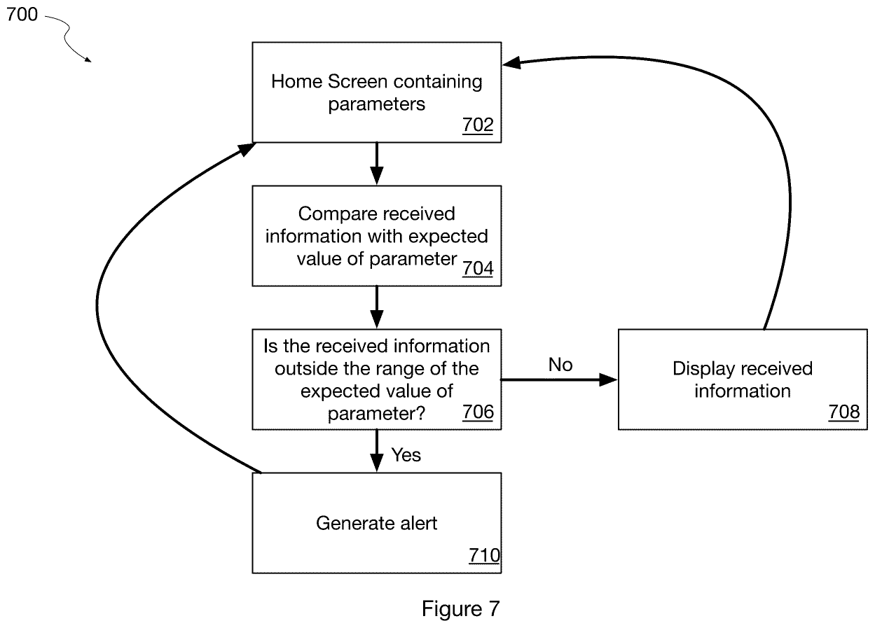

FIG. 7 is a flow chart of a method 700 of operating the hub monitoring system, in accordance with some embodiments. In at least some embodiments, the flow chart depicts the sequence of operations performed by an application executing on the mobile device.

The flow begins at operation 702 wherein the mobile device displays a home screen having the monitored parameters. The monitored parameters include one or more of tire pressure, tire temperature, bearing temperature, or vibration status. In at least some embodiments, the home screen displays the monitored parameters for all tires to which a monitoring module 102 is attached. In at least some embodiments, the home screen is able to be manipulated to display one or more of the monitored parameters for one or more tires to which a monitoring module 102 is attached.

After receipt of information from monitoring module 102 corresponding to one or more monitored parameters, the flow proceeds to operation 704. During operation 704, the received information is compared with a stored expected value of the corresponding parameter. E.g., a tire pressure reading is compared with the expected value for the tire pressure, a bearing temperature reading is compared with the expected value for the bearing temperature. The flow proceeds to operation 706.

During operation 706, a determination is made based on the comparison result. If the received information is within the range (or within a predetermined margin) of the expected value of the corresponding parameter, the flow proceeds to operation 708. In at least some embodiments, the predetermined margin is 5%. In at least some embodiments, the predetermined margin is 10%. In at least some embodiments, the range is a temperature range from nominal air temperature to a predetermined maximum. In at least some embodiments, the predetermined margin varies depending on the parameter being evaluated.

During operation 708, the received information is displayed to the user via the mobile device display, e.g. I/O 610 using UI 616. The flow then proceeds to return to operation 702. In at least some embodiments, operation 708 is skipped and the received information is stored in the mobile device memory.

If, during operation 706, the received information is outside the range of the expected value of the corresponding parameter, the flow proceeds to operation 710.

During operation 710, the received information is displayed to the user via the mobile device display, e.g., I/O 610 using UI 616, and an alert is generated for the user. In at least some embodiments, the alert is one or more of a visual, audio, or haptic signal. In at least some embodiments, the user is required to acknowledge the alert via the mobile device in order for the alert to stop being generated. The flow proceeds to return to operation 702.

In at least some embodiments, more than one alert is generated at a time corresponding to more than one received information being outside the range of an expected value for the parameter.

After returning to operation 702, the flow proceeds again based on received information at the mobile device to proceed through the operations. In at least some embodiments, the received information is received at a different update rate depending on the sensor reporting the information.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A tire monitoring system comprising:
a monitoring module for mounting on a wheel, the monitoring module comprising:
a transmitter configured to wirelessly communicate with a mobile device of a user;
a pneumatic sensor receiver communicatively coupled with the transmitter;
a temperature sensor communicatively coupled with the transmitter; and
a vibration sensor communicatively coupled with the transmitter.

2. The tire monitoring system of claim 1, further comprising a power source.

3. The tire monitoring system of claim 2, wherein the power source is a battery.

4. The tire monitoring system of claim 1, wherein the monitoring module is a circuit board and the transmitter, pneumatic sensor receiver, temperature sensor, and vibration sensor are all mounted thereon.

5. The tire monitoring system of claim 1, wherein the tire monitoring system is configured to be mounted to the hub of a wheel.

6. The tire monitoring system of claim 1, wherein the pneumatic sensor receiver is mounted to the valve stem of the tire.

7. A system, comprising:
a wheel having a hub;
a hub monitoring module positioned adjacent the wheel; and
a hub cap adjacent the hub monitoring module.

8. The system of claim 7, wherein the hub monitoring module is mounted between the hub cap and the wheel.

9. The system of claim 7, wherein the hub monitoring module is mounted to the hub cap.

10. The system of claim 7, wherein the hub cap is mounted to the wheel and the hub monitoring module is mounted to the hub cap.

11. The system of claim 7, further comprising:
a mobile device configured to wirelessly communicate with the hub monitoring module.

12. The system of claim 11, wherein the mobile device is configured to generate an alert in response to information received from the hub monitoring module.

13. The system of claim 12, wherein the information received from the hub monitoring module includes one or more of pressure, temperature, or vibration information.

14. The system of claim 7, further comprising:
an other wheel, the other wheel having a hub;
an other hub monitoring module positioned adjacent the other wheel; and
an other hub cap adjacent the other hub monitoring module.

15. The system of claim 14, wherein the mobile device is further configured to wirelessly communicate with the other hub monitoring module.

16. A method of using a system, the system having a wheel having a hub, a hub monitoring module adjacent the wheel, and a hub cap adjacent the hub monitoring module, the system further comprising a mobile device configured to wirelessly communicate with the hub monitoring module, the method comprising:
the mobile device wirelessly receiving information from the hub monitoring module; and
generating a display of information to a user of the mobile device based on the information received from the hub monitoring module, wherein the information includes one or more of pressure, temperature, or vibration information.

17. The method of claim 16, further comprising:
installing the hub monitoring module between the hub cap and the wheel.

18. The method of claim 16, further comprising:
generating an alert to the user of the mobile device based on a comparison of the information received from the hub monitoring module with parameters stored in the mobile device.

19. The method of claim 18, wherein the alert is generated if the information received from the hub monitoring module differs from the stored parameters by more than a predetermined amount.

20. The method of claim 16, further comprising:
installing the hub cap between the hub monitoring module and the wheel.
